(19) United States
(12) Patent Application Publication
(10) Pub. No.: US 2014/0324571 A1
(43) Pub. Date: Oct. 30, 2014

(54) System and method for selecting and rendering content

(71) Applicant: TENCENT TECHNOLOGY (SHENZHEN) COMPANY LIMITED, Shenzhen (CN)

(72) Inventor: Xing Zhou, Shenzhen (CN)

(21) Appl. No.: 14/324,464

(22) Filed: Jul. 7, 2014

Related U.S. Application Data
(63) Continuation of application No. PCT/CN2014/073006, filed on Mar. 6, 2014.

(30) Foreign Application Priority Data
Mar. 12, 2013 (CN) 2013100783172

(51) Int. Cl. G06Q 30/02; G06Q 50/00

(52) U.S. Cl. CPC G06Q 30/0246; G06Q 30/0277; G06Q 30/0269; G06Q 50/01
USPC 705/14.45

(57) ABSTRACT

System, methods, and computer-readable medium allow rendering content items based on social features. A computer-implemented method includes obtaining social features corresponding to a user identifier, wherein the social features are generated based on behavior data of other user identifiers associated with the user identifier; generating predicted click-through rates (pCTR) of the content items based on the social features; and obtaining content items based on the pCTR for rendering at a terminal.

### CROSS REFERENCE TO RELATED APPLICATIONS

This is a continuation application of International Patent Application No. PCT/CN2014/073006, filed on Mar. 6, 2014, which claims priority to Chinese Patent Application No. 201310078317.2 filed on Mar. 12, 2013, the disclosure of which is hereby incorporated by reference herein in its entirety.

### BACKGROUND

The Internet allows people to browse the same web page while seeing different alternative content, such as ads, which may include multimedia content items. As such, individualized content display may be realized.

### SUMMARY

In an aspect, a method for rendering content items is provided, including: obtaining social features corresponding to a user identifier, wherein the social features are generated based behavior data of other user identifiers associated with the user identifier; generating predicted click-through rates (pCTR) of the content items based on the social features; and obtaining content items based on the pCTR for rendering at a terminal.

In some embodiments, said obtaining content items based on the pCTR for rendering at a terminal includes: sorting the content items according to the corresponding pCTR; and sending the sorted content items to the terminal according to said sorting.

In some embodiments, the method further includes, prior to said sending the sorted content items: determining whether the pCTR is larger than a preset push value; if yes, then rendering the corresponding content item at the terminal; wherein said generating predicted click-through rates (pCTR) of the content items based on the social features comprises including a multiplication factor of 1.0-1.5 or an additive value of 0.0-0.01 in calculating the pCTR, and wherein the multiplication factor and the additive value are associated with the social features.

In some embodiments, the method further includes, prior to said obtaining social features corresponding to a user identifier: obtaining behavior data of other user identifiers associated with the user identifier; generating the user identifiers social features based on the obtained behavior data; and storing the social features of the user identifier.

In some embodiments, the method further includes, prior to said generating predicted click-through rates (pCTR) of the content items based on the social features: obtaining the user identifier's contextual features, wherein the contextual features correspond to current webpage operation behaviors of the user identifier; obtaining content attribute features; and obtaining the user identifiers attribute features.

In some embodiments, said generating predicted click-through rates (pCTR) of the content items based on the social features includes: based on the user identifiers contextual features, the content attribute features, the user identifier's attribute features, and the social features of the user identifier, generating the pCTR of the content items.

In some embodiments, the method further includes: identifying the other user identifiers associated with the user identifier based on at least one of the following social relations: the user identifiers online groups, online chat groups, contact list, an instant messaging group, or a group based on a mobile phone text and voice messaging application; applying a collaborative filtering to the social features; and calculating the pCTR based on a regression model expressed as:

$$P ( Y = 1 \vert x ) = π ( x ) = \frac{1}{1 + {e}^{- g ( x )}} , wherein$$

$$g ( x ) = {β}_{0} + {β}_{1} {x}_{1} + {β}_{2} {x}_{2} + … + {β}_{p} {x}_{p} ,$$

wherein Y represents a click, P represents a probability of Y=1 for a given set of x, wherein x₁, x₂, . . . xₚ respectively correspond to one or more of the contextual features of the user identifier, the content attribute features, the user identifier attribute features, and the user identifier social features, and wherein β are respective weight factors.

In another aspect, a computer-based content distribution system is provided including: a features acquisition portion configured to obtain social features corresponding to a user identifier, wherein the social features are generated based on behavior data of other user identifiers associated with the user identifier; a predicted click-through rate (pCTR) generation portion configured to generate pCTR of content items based on the social features; and a push portion configured to obtain content items based on the pCTR, and render the obtained content items at a terminal.

In some embodiments, the push portion includes: a sorting portion configured to sort the obtained the content items based on the corresponding pCTR; and a rendering portion configured to render the sorted content items at the terminal according to said sorting.

In some embodiments, the push portion further comprises a determining portion configured to determine whether the pCTR is greater than a preset push value; if yes, then the push portion renders the corresponding content item at the terminal, wherein the pCTR generation portion is further configured to a multiplication factor of 1.0-1.5 or an additive value of 0.0-0.01 in calculating the pCTR, and wherein the multiplication factor and the additive value are associated with the social features.

In some embodiments, the system further includes: an associated data acquisition portion configured to obtain the user identifier's social features based on the obtained behavior data; a social features generation portion configured to generate said user identifier's social features based on the obtained behavior data; and a storage portion configured to store said user identifiers social features.

In some embodiments, the system further includes: an information acquisition portion configured to obtain contextual features of the user identifier, attribute features of the content items, and the user identifiers attribute features; wherein the contextual features correspond to current webpage operation behaviors of the user identifier.

In some embodiments, the pCTR generation portion is further configured to generate the pCTR based on the user identifiers contextual features obtained by the information acquisition portion, the attribute features of the content items, the attribute features of the user identifier, and the social features obtained by the features acquisition portion.

In another aspect, a non-transitory computer-readable storage medium is provided storing instructions thereon for execution by at least one processing circuit for rendering content items, the instructions including: obtaining social features corresponding to a user identifier, wherein the social features are generated based behavior data of other user identifiers associated with the user identifier; generating predicted click-through rates (pCTR) of the content items based on the social features; and obtaining content items based on the pCTR for rendering at a terminal.

In some embodiments, said obtaining content items based on the pCTR for rendering at a terminal comprises: sorting the content items according to the corresponding pCTR; sending the sorted content items to the terminal according to said sorting.

In some embodiments, the instructions further include, prior to said sending the sorted content items: determining whether the pCTR is larger than a preset push value; if yes, then rendering the corresponding content item at the terminal, wherein said generating predicted click-through rates (pCTR) of the content items based on the social features comprises including a multiplication factor of 1.0-1.5 or an additive value of 0.0-0.01 in calculating the pCTR, and wherein the multiplication factor and the additive value are associated with the social features.

In some embodiments, the instructions further include, prior to said obtaining social features corresponding to a user identifier: obtaining behavior data of other user identifiers associated with the user identifier; generating the user identifiers social features based on the obtained behavior data; and storing the social features of the user identifier.

In some embodiments, the instructions further include, prior said generating predicted click-through rates (pCTR) of the content items based on the social features: obtaining the user identifier's contextual features, wherein the contextual features correspond to current webpage operation behaviors of the user identifier; obtaining content attribute features; and obtaining the user identifiers attribute features.

In some embodiments, said generating predicted click-through rates (pCTR) of the content items based on the social features includes: based on the user identifiers contextual features, the content attribute features, the user identifier's attribute features, and the social features of the user identifier, generating the pCTR of the content items.

In some embodiments, the instructions further include: identifying the other user identifiers associated with the user identifier based on a group based on a mobile phone text and voice messaging application; applying a collaborative filtering to the social features; and calculating the pCTR based on a regression model expressed as:

$$P ( Y = 1 \vert x ) = π ( x ) = \frac{1}{1 + {e}^{- g ( x )}} , wherein$$

$$g ( x ) = {β}_{0} + {β}_{1} {x}_{1} + {β}_{2} {x}_{2} + … + {β}_{p} {x}_{p} ,$$

wherein Y represents a click, P represents a probability of Y=1 for a given set of x, wherein x₁, x₂, . . . xₚ respectively correspond to one or more of the contextual features of the user identifier, the content attribute features, the user identifier attribute features, and the user identifier social features, and wherein β are respective weight factors.

In another aspect, a server is provided including: a features acquisition portion configured to obtain social features corresponding to a user identifier, wherein the social features are generated based on behavior data of other user identifiers associated with the user identifier; a predicted click-through rate (pCTR) generation portion configured to generate pCTR of content items based on the social features; and a push portion configured to sort and obtain content items based on the pCTR, and send the obtained content items to a terminal.

In some embodiments, the push portion is further configured to determine whether the pCTR is greater than a preset push value; if yes, then the corresponding content item is rendered at the terminal, wherein the pCTR generation portion is further configured to include a multiplication factor of 1.0-1.5 or an additive value of 0.0-0.01 in calculating the pCTR, and wherein the multiplication factor and the additive value are associated with the social features.

In some embodiments, the server further includes: an associated data acquisition portion configured to obtain the user identifier's social features based on the obtained behavior data; a social features generation portion configured to generate said user identifier's social features based on the obtained behavior data; and a storage portion configured to store said user identifiers social features.

In some embodiments, the server further includes an information acquisition portion configured to obtain contextual features of the user identifier, attribute features of the content items, and the user identifiers attribute features; wherein the contextual features correspond to current webpage operation behaviors of the user identifier.

In some embodiments, the pCTR generation portion is further configured to generate the pCTR based on the user identifiers contextual features obtained by the information acquisition portion, the attribute features of the content items, the attribute features of the user identifier, and the social features obtained by the features acquisition portion.

In some embodiments, the other user identifiers associated with the user identifier are identified based on a pier-to-pier instant messaging service; and wherein the pCTR generation portion is further configured to: apply a collaborative filtering to the social features; and calculate the pCTR based on a regression model expressed as:

$$P ( Y = 1 \vert x ) = π ( x ) = \frac{1}{1 + {e}^{- g ( x )}} , wherein$$

$$g ( x ) = {β}_{0} + {β}_{1} {x}_{1} + {β}_{2} {x}_{2} + … + {β}_{p} {x}_{p} ,$$

wherein Y represents a click, P represents a probability of Y=1 for a given set of x, wherein x₁, x₂, . . . xₚ respectively correspond to one or more of the contextual features of the user identifier, the content attribute features, the user identifier attribute features, and the user identifier social features, and wherein β are respective weight factors.

### BRIEF DESCRIPTION OF THE DRAWINGS

FIG. 1A is a block diagram illustrating relationships among multiple parties involved in content rendering;

FIG. 1B is a flowchart of a content item rendering method according to some embodiments;

FIG. 1C is a block diagram illustrating a QQ group according to some embodiments;

FIG. 1D is a schematic diagram illustrating rendering a content item according to some embodiments;

FIG. 1E is a schematic diagram illustrating rendering a content item according to some other embodiments;

FIG. 2 is a flowchart of generating social features according to some embodiments;

FIG. 3 is a flowchart of a content item rendering method according to some other embodiments;

FIG. 4 is a block diagram illustrating a server according to some embodiments; and

FIG. 5 is a block diagram illustrating a system according to some embodiments.

### DETAILED DESCRIPTION

A web page such as that provided by a publisher, a content provider, or a search engine server can display content items that are the same for many user identifiers viewing the same web page, as well as alternative content items specific to a user identifier. Such alternative content items may be advertisements selected and rendered specifically for the user identifier. The advertisements may include multimedia presentations. The advertisements may be selected and ranked based on a predicted click-through rate (pCTR).

For example, based on the contextual and other features of content items, as well as user identifier features, statistical methods or training can be employed to generate a pCTR model. Sometimes advertisement pricing can be determined from actions such as clicks on, and impressions (such as displaying) of, a content item. In an example, an effective cost per thousand impression (eCPM) can be calculated from an auctioned price multiplying the pCTR, and advertisements can be displayed according to an inverse order of the eCPM.

The pCTR model can take into account contextual features of content (such as user identifiers' search queries, webpage content viewed by user identifiers, etc.), content of advertisements (such as the titles of the ads, the descriptions, the addresses of the landing pages, etc.), and individualized user identifier features (such as ages, genders, locations, etc.)

Embodiments disclosed herein further take into account the effects of the connections among user identifiers for CTR predictions. By including social features, such as user identifiers' social attributes obtained from social networks, the user identifier experience may be improved, and the rate of conversion for ads may be increased.

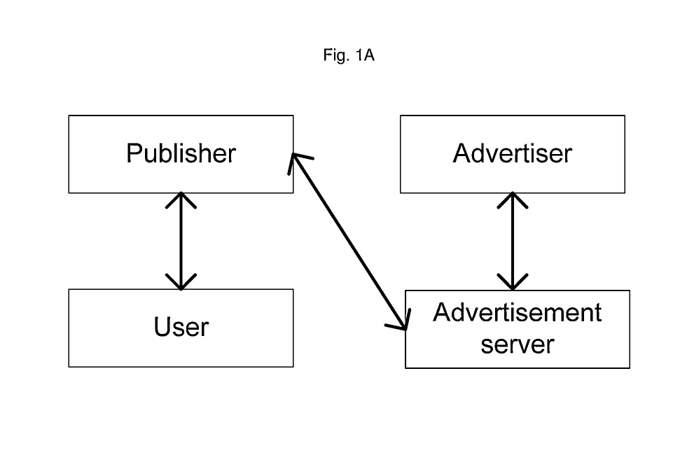

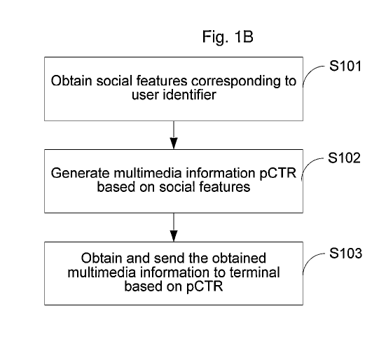

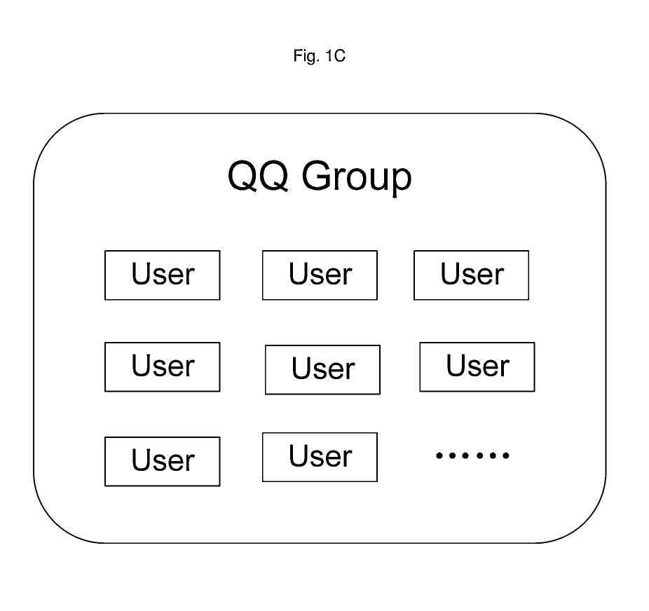

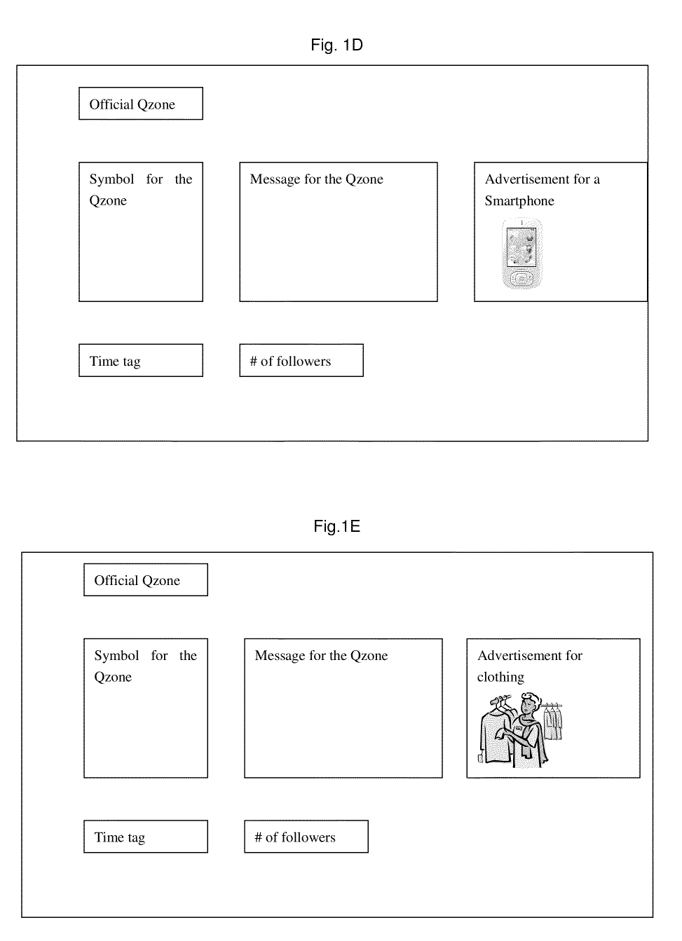

FIG. 1A is a block diagram illustrating possible relationships among parties that may be involved in content rendering. For example, an advertisement server can obtain content from a publisher, as well as advertisements from an advertiser. Users visiting the publisher's web pages can access both the content as desired and advertisements potentially of interest to the users.

FIG. 1B is a flowchart of a content rendering method according to some embodiments.

In step S101, social features, such as associated with social networking corresponding to a user identifier, may be obtained.

The user identifier may be a unique user identifier, such as a user account. The social features may be generated from behavioral data of other user identifiers associated with or related to the user identifier. The behavior data may include the clicks on the relevant content items, the purchases, uses, or impressions, etc. of the related items. The behavior data may also include viewing of micro blogs, liking friends' interests, or purchasing behaviors.

In an example, user identifier A's friends often buy sports clothing or watch football games. In another example, user identifier A's friends joined an online social group (such as a LinkedIn group, a QQ group, a BBS, a social or interest group based on mobile phone text and voice messaging applications (such as a WeChat group), a tweeter group, a microblog group, a meetup group, a Google circle, or a Facebook group, etc.) that is related to sports. In yet another example, user identifier A's friends viewed or liked an athlete's blogs, website, or Facebook page. WeChat can obtain the interests from user identifier A's friends, and chooses the most popular interest for advertisement targeting. For example, Wetchat can set up a map for every identifier. The map key may be the identifier's id, and the identifiers friends' interests may be the map values. The map can be updated periodically, for example every five seconds, to capture the up-to-date interests from the identifiers' friends. Based on one of more of the above, it may be inferred that user identifier A possibly would be also interested in sports. Accordingly, when selecting content items (e.g., ads) for rendering to user identifier A, a higher pCTR may be given for sports-related content items. Various algorithms may be used to take into account social features in pCTR calculations. In some implementations, a multiplication numerical factor (e.g., 1.0-1.5, such as 1.2) may included in the calculation of the pCTR (e.g., multiplied to the pCTR). In some other implementations, an additive numerical value (e.g., 0.0-0.01, such as 0.0001) may be included in the calculation of the pCTR (e.g., added to the pCTR).

In step S102, based on features of the social activities, pCTR for specified content items may be generated.

The social features may include, for example, a user identifier's social relationships such as classmates, colleagues, or friends, etc. These related or associated user identifiers' behaviors can be used in the process of generating the pCTR.

In step S103, based on the pCTR, the corresponding content items can be obtained and rendered to the terminal.

The content items (e.g., ads) selected, ranked, and rendered according to the above method can better reflect social relationships among user identifiers. As such, a higher recommendations efficiency, an improved server efficiency, a better resource utilization, and a lower cost may be achieved.

Embodiments disclosed herein may be applied to software tools such as Instant Messaging (IM) using peer-to-peer (P2P) technologies. One of such software tools may include “QQ,” produced and issued by Tencent Co., Ltd. A conventional user terminal may display a QQ chat window by using an IM tool. QQ user identifiers may be classified according to different specifications. For example, user identifiers in a QQ chat window may be classified into a QQ contact list, QQ user identifiers in an address book, QQ user identifiers in a list of chat groups, and QQ user identifiers in a list of QQ user identifiers recently chatted with.

The QQ contact list may be updated by adding more contacts therein. The contacts may be arranged by contact names or by QQ IDs in a list. The QQ address book may record contact information of a QQ user identifier, e.g., a phone number, an address, an e-mail address, etc. The list of QQ chat groups may record QQ chat groups which the user identifier participated in, and QQ user identifiers in each QQ chat group. QQ user identifiers which the user identifier has recently chatted with may be recorded within a period of time according to configurations pre-set in the IM tool.

When a user identifier logs onto an IM system via an IM tool, a user terminal may I requests to receive classification information for a chat window of the QQ user identifier from a QQ server, and displays the information to the user identifier. For example, information of a QQ contact list is may be from the QQ server, and all contacts of the QQ user identifiers may be are displayed in a list together with their states. A QQ chat window may subsequently be updated according to configurations in the QQ server or in the user terminal; when the user identifier logs off, with the user identifiers consent, the QQ server may stores history information of the user identifier.

FIG. 1C is a block diagram illustrating a QQ group according to some embodiments.

FIG. 1D is a schematic diagram illustrating rendering a content item according to some embodiments. For example, in a social networking service webpage “Qzone” directed to a winter message, if user identifier A browses the Qzone, an ad about a smart phone may be rendered from the ad server, for example, based on interests or attribute information of user identifier A.

FIG. 1E is a schematic diagram illustrating rendering a content item according to some other embodiments. For example, if it is known that user identifier A's friends are young users who like clothing of certain origin or certain brands, the ad server may select certain clothing based on the friends' interests, and such an ad may suit user identifier A better, resulting in higher probability of user identifier A's clicking the ad as compared with the ad of smart phone as illustrated in FIG. 1D.

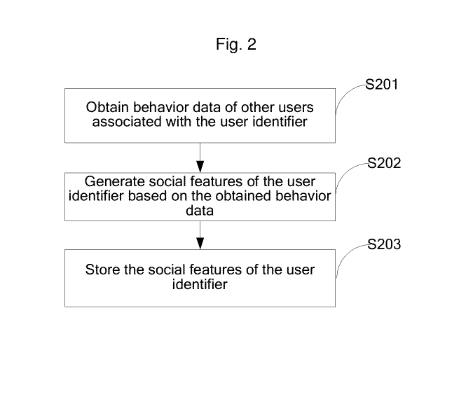

FIG. 2 is a flowchart of a method of generating social features according to some embodiments.

In step S201, behavior data of other user identifiers associated with the user identifier may be obtained.

For example, behavior data of the user identifier's classmates, friends, or colleagues may be obtained. The behavior data may include, for example, clicks of relevant content items, purchases of related items, use or impression behaviors, etc.

In step S202, social features of the user identifier may be generated based on the obtained behavior data.

For example, the social features may include behavior data information of other user identifiers related to the user identifier. The social features may be obtained from the user identifiers social relationship chains, for example, based on social networks such as friends network, micro blogs, etc. The social features may also be obtained based on mining the user identifier's social features using user-based collaborative filtering (CF) technologies. Using such CF technologies, automatic predictions (filtering) of the user identifier's interests may be made by obtaining preference information from many other user identifiers.

CF technologies can be used by various recommendation systems, for example, by filtering for information or patterns using techniques involving collaboration among multiple agents, viewpoints, data sources, etc., and CF methods can be applied to many different types of data. For instance, user identifier A likes travelling, cooking, and music, user identifier B likes travelling and cooking, and based on CF analysis, it may be inferred that user identifier B may also have the interest of music. In some embodiments, the social features may be based on the user identifier's attribute features such as education, work, and hobbies such as sports, digital, music, etc.

In step S203, the social features of the user identifier may be stored, after obtaining the social features information of the behavior data information of other user identifiers related to the user identifier. If the behavior data of the other user identifiers related to the user change, the storage may be promptly updated to ensure the accuracy of the social features of the user identifier.

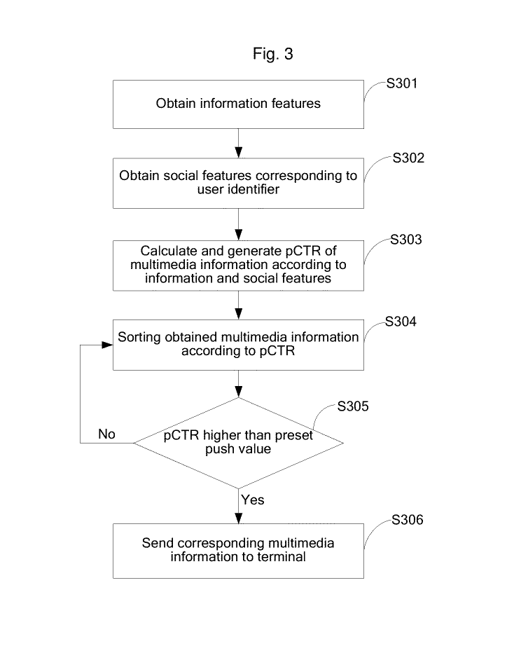

Referring to FIG. 3, which illustrates a flowchart of content rendering method according to some embodiments.

In step S301, information features may be obtained.

The information features may include, for example, contextual features of the user identifier, attribute features of the content, and the user identifiers attribute features.

The user identifier's contextual features may correspond to webpage operation behaviors of the user identifier. The webpage operation behaviors may include, for example, search queries of content items, wherein the search queries may correspond to a user identifier. The webpage operation behaviors may also include related behaviors such as webpage browsing, etc. For example, the current user identifier's browsing sports-related websites may be a contextual features having implications on pCTR.

The attribute features of the content may include format of the content items, such as textual information, video information, etc. User identifier attribute features may include the user identifier's education, age, and social positions, etc.

In step S302, social features corresponding to the user identifier may be obtained.

For example, the social features may be generated from the behavior data of other user identifiers related to said user identifier, as described in more details in FIG. 2 and its associated text.

In step S303, based on the obtained information features and the user identifiers social features, pCTR of the content items may be calculated and generated.

The information features may include contextual features of search queries, attribute features of the content items, attributes of the user identifier, etc. For example, the contextual features, the attributes of the content items, the attribute features of the user identifier, and the social features of the user identifier may be taken as inputs to a logical regression model. An example of such regression models may be expressed as:

$$P ( Y = 1 \vert x ) = π ( x ) = \frac{1}{1 + {e}^{- g ( x )}} , wherein$$

$$g ( x ) = {β}_{0} + {β}_{1} {x}_{1} + {β}_{2} {x}_{2} + … + {β}_{p} {x}_{p} .$$

wherein x may represent a logical regression model input, Y may represent a click, and P may indicate the probability of Y=1 given x. For example, x₁ may correspond to one or more of the contextual features of the user identifier, x₂ may correspond to one or more of the content attribute features, x₃ may correspond to one or more of the user identifier attribute features, x₄ may correspond to one or more of the user identifier social features, etc. β can be weight factors respectively corresponding to each of the inputs. For example, if p=2, β₀=1, β₁=0.5, β₂=0.1, x₁=0, and x₂=1, then P(Y=1|x)=0.750260.

The logical regression model can be generated from training. The inputs may be entered into the trained logical regression model. The pCTR of the content item can then be obtained. The pCTR can reflect the user identifier contextual features, content attribute features, attribute features and social features of the user identifiers, and other inputs. The logical regression model training and generation can be a process of selecting a model of appropriate inputs and outputs to the logical regression model, such that the outputs of the logical regression model generated from training can accurately reflect the user identifier's contextual features, content attribute features, user identifier attribute features, and social features of the user identifier, etc.

In step S304, the obtained content items may be sorted based on the pCTR.

For example, the obtained content items may be sorted based on the value of the pCTR, such as from high to low, or alternatively can be in ascending order.

In step S305, it may be determined whether the pCTR value is greater than a preset push value. If yes, then proceed to step S306; otherwise, proceed to step S304.

For example, based on needs, a push value may be preset. When the pCTR value for a content item is greater than the preset push value, then the content item may be rendered. The preset push value can be set based on various needs. For example, it can be set to 60%, 65%, 70%, or 90%, etc., whereby content items with a higher pCTR can be pushed to the terminal. As such, the efficiency of the content rendering can be improved.

In step S306, the sorted content items may be transmitted to the terminal according to the sorted order.

For example, is the content item has a pCTR value greater than the preset push value, the content item may be pushed to the terminal. When sending the terminal the content item, the higher pCTR value may have a higher ranking, and the corresponding content item may a higher priority to be rendered.

As discussed above, according to some of the disclosed embodiments, by obtaining the social features corresponding to the user identifier, generating the pCTR of the content items based on social features, obtaining the corresponding content items according to the pCTR, and rendering the obtained content items at the terminal, the relationships among user identifiers are included in the modeling and prediction, resulting in a higher recommendation efficiency, improved server operation efficiency and resource utilization efficiency. System adopting these methods can therefore have a higher content rendering efficiency and a lower cost.

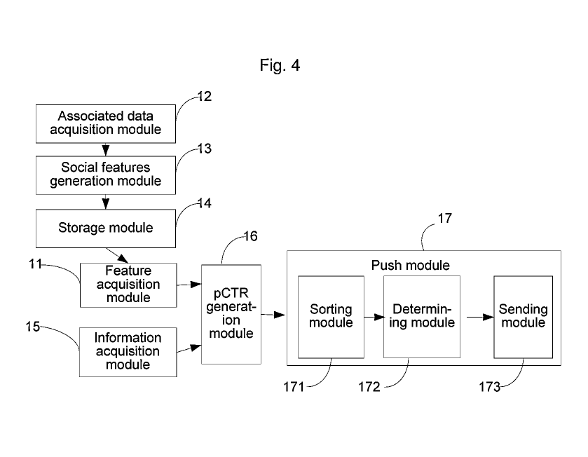

Refer to FIG. 4, which is block diagram showing a structure of a server according to some embodiments. The server may includes, for example, a features acquisition portion 11, an associated data acquisition portion 12, a social features generation portion 13, a storage portion 14, an information acquisition portion 15, a predicted CTR generation portion 16, and a push portion 17.

The associated data acquisition portion 12 can obtain the behavior data of other user identifiers associated with the user identifier. The social features generation portion 13 can generate, based on the behavior data obtained by the associated data acquisition portion 12, the user identifier's social features. The storage portion 14 can store the social features of the user identifier generated by the social features generation portion 13.

The features acquisition portion 11 can obtain, from the storage portion 14, the social features corresponding to the user identifier. The social features may be generated based on behavior data of other user identifiers associated with the user identifier. The pCTR generation portion 16, based on the social features obtained by the features acquisition portion 11, can generate pCTR of the content items. The push portion 17, based on the pCTR generated by the pCTR generation portion 16, can obtain the corresponding content items, and render the obtained content items to the terminal.

The information obtaining portion 15 can obtain information features, such as contextual features, multimedia attribute features, and attribute features of the user identifier. The user identifier contextual features may correspond to the current webpage operation behaviors of the user identifier. Such operation behaviors may include, for example, content search queries. The content information search query may correspond to a user identifier. The operation behaviors on the webpage can also include related behaviors such as web browsing, for example, the current user identifier's browsing sports-related web pages. The attribute features of the content may including information format of the content items, such as textual information, video information, etc. The user identifier attribute features may include the user's education, age, and social position, etc.

The pCTR generation portion 16, further based on information features obtained by the information acquisition portion 15, and the social features obtained by the social feature acquisition portion 11, can generate the pCTR for various content items.

The push portion 17 may include a sorting portion 171, a determining portion 172, and a transmission portion 173. The sorting portion 171, based on the pCTR, can sort the corresponding content items. The determining portion 172 can determine whether the predicted CTR is greater than the preset push value. If yes, the transmission portion 173 can send the corresponding content items to the terminal. As such, the transmission portion 173 may be used for sending the already-sorted content items with pCTR higher than the preset push value to the terminal.

In the server or in a system, the feature acquisition portion 11 can obtain the social features corresponding to the user identifier, the predicted CTR generation portion 16 can generate pCTR of the content items according to the social features, the push portion 17 can obtain the corresponding content items according to the pCTR, and send the obtained content items to the terminal. As such, the embodiments disclosed herein can better reflect the relationships among user identifiers, and therefore can realize a higher recommendation efficiency, improve the operation efficiency of the server, increased resource utilization, and a lower cost.

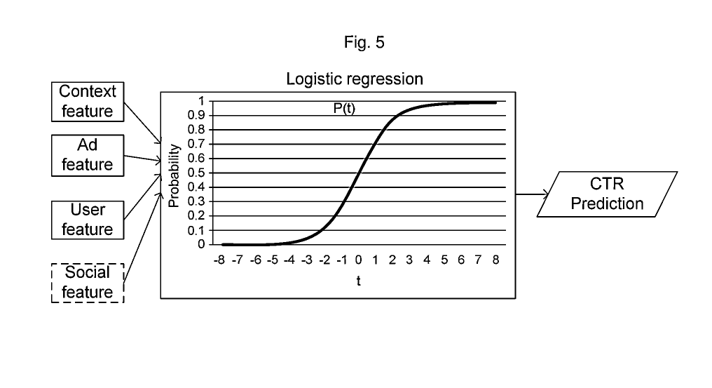

FIG. 5 is a block diagram illustrating a system according to some embodiments. The system may include the server illustrated in FIG. 4, and adopt the methods illustrated in FIGS. 1-3. For example, the system can obtain contextual features 51, Ad features 52, user identifier features 53, and social identifiers 54. These features can be fed to a logical regression model 55, which can calculate the pCTR for the ads as output 56.

In an example, if a user identifier searches “cars” through a search engine, the advertising system may have a list of candidate ads. The system may predict each candidate ads' pCTR, for example based on the contextual features (e.g., “cars” as in the user identifier's search query), the features of the ads (e.g., textual information in the candidate ads), and user identifier features (e.g., age, location, etc.). The system according to some of the disclosed embodiments also bring in social features. For example, it may be determined that this user identifiers friends or online groups are interested in cars with certain brand names (e.g., BMW, Mercedes-Benz, etc.), then the logical regression model 55 may give higher pCTR to ads related to luxury cars, and such ads may be selected for rendering to the user identifier's terminal. For another example, if the user identifier's friends are sharing links in WeChat about car renovation, then ads about car renovation may be recommended.

All references cited in the description are hereby incorporated by reference in their entirety. While the disclosure has been described with respect to a limited number of embodiments, those skilled in the art, having benefit of this disclosure, will appreciate that other embodiments can be advised and achieved which do not depart from the scope of the description as disclosed herein.

1. A method for rendering content items, comprising:
obtaining social features corresponding to a user identifier, wherein the social features are generated based behavior data of other user identifiers associated with the user identifier;
generating predicted click-through rates (pCTR) of the content items based on the social features; and
obtaining content items based on the pCTR for rendering at a terminal.

2. The method of claim 1, wherein said obtaining content items based on the pCTR for rendering at a terminal comprises:
sorting the content items according to the corresponding pCTR;
sending the sorted content items to the terminal according to said sorting.

3. The method of claim 2, further comprising, prior to said sending the sorted content items:
determining whether the pCTR is larger than a preset push value; if yes, then rendering the corresponding content item at the terminal;
wherein said generating predicted click-through rates (pCTR) of the content items based on the social features comprises including a multiplication factor of 1.0-1.5 or an additive value of 0.0-0.01 in calculating the pCTR, and
wherein the multiplication factor and the additive value are associated with the social features.

4. The method of claim 1, further comprising, prior to said obtaining social features corresponding to a user identifier:
obtaining behavior data of other user identifiers associated with the user identifier;
generating the user identifier's social features based on the obtained behavior data; and
storing the social features of the user identifier.

5. The method of claim 1, further comprising, prior to said generating predicted click-through rates (pCTR) of the content items based on the social features:
obtaining the user identifier's contextual features, wherein the contextual features correspond to current webpage operation behaviors of the user identifier;
obtaining content attribute features; and
obtaining the user identifier's attribute features.

6. The method of claim 5, wherein said generating predicted click-through rates (pCTR) of the content items based on the social features comprises:
based on the user identifier's contextual features, the content attribute features, the user identifier's attribute features, and the social features of the user identifier, generating the pCTR of the content items.

7. The method of claim 6, further comprising:
identifying the other user identifiers associated with the user identifier based on at least one of the following social relations: the user identifier's online groups, online chat groups, contact list, an instant messaging group, or a group based on a mobile phone text and voice messaging application;
applying a collaborative filtering to the social features; and
calculating the pCTR based on a regression model expressed as:
$$P ( Y = 1 \vert x ) = π ( x ) = \frac{1}{1 + {e}^{- g ( x )}} , wherein$$
$$g ( x ) = {β}_{0} + {β}_{1} {x}_{1} + {β}_{2} {x}_{2} + … + {β}_{p} {x}_{p} ,$$
wherein Y represents a click, P represents a probability of Y=1 for a given set of x,
wherein x₁, x₂, . . . xₚ respectively correspond to one or more of the contextual features of the user identifier, the content attribute features, the user identifier attribute features, and the user identifier social features,
wherein β are respective weight factors.

8. A computer-based content distribution system comprising:
a features acquisition portion configured to obtain social features corresponding to a user identifier, wherein the social features are generated based on behavior data of other user identifiers associated with the user identifier;
a predicted click-through rate (pCTR) generation portion configured to generate pCTR of content items based on the social features; and
a push portion configured to obtain content items based on the pCTR, and render the obtained content items at a terminal.

9. The system of claim 8, wherein the push portion comprises:
a sorting portion configured to sort the obtained the content items based on the corresponding pCTR; and
a rendering portion configured to render the sorted content items at the terminal according to said sorting.

10. The system of claim 9, wherein the push portion further comprises a determining portion configured to determine whether the pCTR is greater than a preset push value; if yes, then the push portion renders the corresponding content item at the terminal, wherein the pCTR generation portion is further configured to a multiplication factor of 1.0-1.5 or an additive value of 0.0-0.01 in calculating the pCTR, and wherein the multiplication factor and the additive value are associated with the social features.

11. The system of claim 8, further comprising:
an associated data acquisition portion configured to obtain the user identifier's social features based on the obtained behavior data;
a social features generation portion configured to generate said user identifier's social features based on the obtained behavior data; and
a storage portion configured to store said user identifier's social features.

12. The system of claim 8, further comprising an information acquisition portion configured to obtain contextual features of the user identifier, attribute features of the content items, and the user identifier's attribute features; wherein the contextual features correspond to current webpage operation behaviors of the user identifier.

13. The system of claim 12, wherein the pCTR generation portion is further configured to generate the pCTR based on the user identifier's contextual features obtained by the information acquisition portion, the attribute features of the content items, the attribute features of the user identifier, and the social features obtained by the features acquisition portion.

14-20. (canceled)

21. A server comprising:
a features acquisition portion configured to obtain social features corresponding to a user identifier, wherein the social features are generated based on behavior data of other user identifiers associated with the user identifier;
a predicted click-through rate (pCTR) generation portion configured to generate pCTR of content items based on the social features; and
a push portion configured to sort and obtain content items based on the pCTR, and send the obtained content items to a terminal.

22. The server of claim 21, wherein the push portion is further configured to determine whether the pCTR is greater than a preset push value; if yes, then the corresponding content item is rendered at the terminal, wherein the pCTR generation portion is further configured to include a multiplication factor of 1.0-1.5 or an additive value of 0.0-0.01 in calculating the pCTR, and wherein the multiplication factor and the additive value are associated with the social features.

23. The server of claim 21, further comprising:
an associated data acquisition portion configured to obtain the user identifier's social features based on the obtained behavior data;
a social features generation portion configured to generate said user identifier's social features based on the obtained behavior data; and
a storage portion configured to store said user identifier's social features.

24. The server of claim 21, further comprising an information acquisition portion configured to obtain contextual features of the user identifier, attribute features of the content items, and the user identifier's attribute features; wherein the contextual features correspond to current webpage operation behaviors of the user identifier.

25. The server of claim 24, wherein the pCTR generation portion is further configured to generate the pCTR based on the user identifier's contextual features obtained by the information acquisition portion, the attribute features of the content items, the attribute features of the user identifier, and the social features obtained by the features acquisition portion.

26. The server of claim 25, wherein the other user identifiers associated with the user identifier are identified based on a pier-to-pier instant messaging service; and wherein the pCTR generation portion is further configured to:
apply a collaborative filtering to the social features; and
calculate the pCTR based on a regression model expressed as:
$$P ( Y = 1 \vert x ) = π ( x ) = \frac{1}{1 + {e}^{- g ( x )}} , wherein$$
$$g ( x ) = {β}_{0} + {β}_{1} {x}_{1} + {β}_{2} {x}_{2} + … + {β}_{p} {x}_{p} ,$$
wherein Y represents a click, P represents a probability of Y=1 for a given set of x,
wherein x₁, x₂, . . . xₚ respectively correspond to one or more of the contextual features of the user identifier, the content attribute features, the user identifier attribute features, and the user identifier social features, and
wherein β are respective weight factors.
